(19) United States
(12) Patent Application Publication
(10) Pub. No.: US 2014/0309787 A1
(43) Pub. Date: Oct. 16, 2014

(54) DEVICE CONTROL SYSTEM AND CONTROLLER

(71) Applicant: KABUSHIKI KAISHA YASKAWA DENKI, Kitakyushu-shi (JP)

(72) Inventors: Takeshi NAGATA, Kitakyushu-shi (JP); Kenichi HIROSE, Kitakyushu-shi (JP); Koji HARA, Kitakyushu-shi (JP)

(73) Assignee: KABUSHIKI KAISHA YASKAWA DENKI, Kitakyushu-shi (JP)

(21) Appl. No.: 14/251,650

(22) Filed: Apr. 14, 2014

(30) Foreign Application Priority Data
Apr. 15, 2013 (JP) 2013-085321

(51) Int. Cl. G05D 15/01

(52) U.S. Cl. CPC G05D 15/01
USPC 700/275

(57) ABSTRACT

A device control system includes a controller to control a device including a motor drive shaft. An operation terminal is communicably coupled to the controller. An external instruction synchronized drive command device notifies the controller of a drive command for external instruction synchronized drive of the motor drive shaft. A periodic communication device communicates with the controller at a predetermined period at least during the external instruction synchronized drive. An external instruction synchronized drive execution device executes the external instruction synchronized drive based on the drive command. The external instruction synchronized operation execution stopping device monitors communication from the periodic communication device at least during the external instruction synchronized drive, and stops the external instruction synchronized drive when the communication is interrupted.

### CROSS-REFERENCE TO RELATED APPLICATIONS

The present application claims priority under 35 U.S.C. §119 to Japanese Patent Application No. 2013-085321, filed Apr. 15, 2013. The contents of this application are incorporated herein by reference in their entirety.

### BACKGROUND

1. Field of the Invention

The present invention relates to a device control system and a controller.

2. Discussion of the Background

Japanese Unexamined Patent Application Publication No. 2011-175351 discloses setting a jog/inching command issuing timing of a switch generated on a display device. The display device is coupled to a Programmable Logic Controller (PLC) and a multi-axis controller through serial communication cables. Specifically, the set jog/inching command issuing timing is when the switch is pressed or released (paragraphs 0029 and 0059).

### SUMMARY

According to one aspect of the present disclosure, a device control system includes a controller and an operation terminal. The controller is configured to control a device including a motor drive shaft. The operation terminal is communicably coupled to the controller. The operation terminal includes an external instruction synchronized drive command device and a periodic communication device. The external instruction synchronized drive command device is configured to notify the controller of a drive command for external instruction synchronized drive of the motor drive shaft. The periodic communication device is configured to communicate with the controller at a predetermined period at least during the external instruction synchronized drive. The controller includes an external instruction synchronized drive execution device and an external instruction synchronized operation execution stopping device. The external instruction synchronized drive execution device is configured to execute the external instruction synchronized drive based on the drive command. The external instruction synchronized operation execution stopping device is configured to monitor communication from the periodic communication device at least during the external instruction synchronized drive, and is configured to stop the external instruction synchronized drive when the communication from the periodic communication device is interrupted.

According to another aspect of the present disclosure, a device control system includes a controller and an operation terminal. The controller is configured to control a device including a motor drive shaft. The operation terminal is communicatively coupled to the controller. The operation terminal includes a periodic communication device configured to communicate with the controller at a predetermined period. The controller is configured to monitor communication from the periodic communication device, and is configured to stop the motor drive shaft when the communication from the periodic communication device is interrupted.

According to the other aspect of the present disclosure, a controller is used in the above-described device control system.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a schematic view of an exemplary device control system according to an embodiment;

FIG. 2 is a bock diagram illustrating a physical configuration of an operation terminal;

FIG. 3 is a functional block diagram illustrating the device control system;

FIG. 4 is a diagram illustrating an exemplary operation window that an operation terminal displays on an image display device where a continuous drive operation window is selected as the operation window;

FIG. 5 is a diagram illustrating an exemplary operation window where a normal rotation direction displacement setting operation window is selected as the operation window;

FIG. 6 is a diagram illustrating an exemplary operation window where a reverse rotation direction displacement setting operation window is selected as the operation window;

FIG. 7 is a diagram illustrating an exemplary operation window where an absolute position setting operation window is selected as the operation window; and

FIG. 8 is a diagram illustrating an exemplary operation window 14 where an origin return operation window is selected as the operation window 14.

### DESCRIPTION OF THE EMBODIMENTS

The embodiments will now be described with reference to the accompanying drawings, wherein like reference numerals designate corresponding or identical elements throughout the various drawings.

As far as the inventors know, in manual operation of a motor drive shaft such as a servo shaft, it is common practice to connect a switch for direct manual operation to a terminal at a controller of the servo shaft, and to operate the motor shaft only when the switch is ON. When the switch is not connected to the terminal, the switch is regarded as being in OFF state. Thus, when the wiring between the switch and the controller is broken, the servo shaft immediately stops its operation.

The connecting wire between the controller and the switch is constantly occupied by a signal indicating the state of the switch. Specifically, a high or low signal indicating that the switch is ON or OFF is constantly applied to the connecting wire. In the following description, such a communication connection is referred to as an occupied communication.

Factory Automation (FA) has become highly sophisticated and complex. This has led to widespread use of unoccupied communication to simplify the communication connection between industrial devices. As used herein, the unoccupied communication refers to a type of communication where various types of information are transmitted through a data connection wire on a time-division basis, instead of the data connection wire being dedicated to a specific type of information. The unoccupied communication includes a wide variety of information communication methods such as serial communication and packet communication. The unoccupied communication also includes wireless transmission. Instead of using physical switches, virtual switches implemented on graphical user interfaces (GUI) such as touch panels are often used.

With the unoccupied communication, it is difficult or impossible to constantly acquire the state of the switch from a connection destination device, as opposed to the occupied communication. An exemplary way of acquiring the state of the switch is to make a notification in the form of information indicating that the state of a switch, physical or virtual, has changed.

Here, using the unoccupied communication to manually operate a motor drive shaft can disable the notification of the switch being turned OFF when communication interruptions occur due to breakage of the communication wire or other causes. This, in turn, can disable the stopping of the operation of the motor drive shaft. Additionally, in using a GUI to manually operate the motor drive shaft, no or minimal consideration has been paid to how to construct the GUI in order to reduce mal-operations caused by human errors and other errors.

In view of this, the inventors studied and developed a device control system that controls a device including a motor drive shaft in an attempt to improve the safety of driving the motor drive shaft. As a result, the inventors conceived of a novel and unique device control system and controller. An embodiment of the unique device control system and controller will be described in detail below.

### Device Control System According to the Embodiment

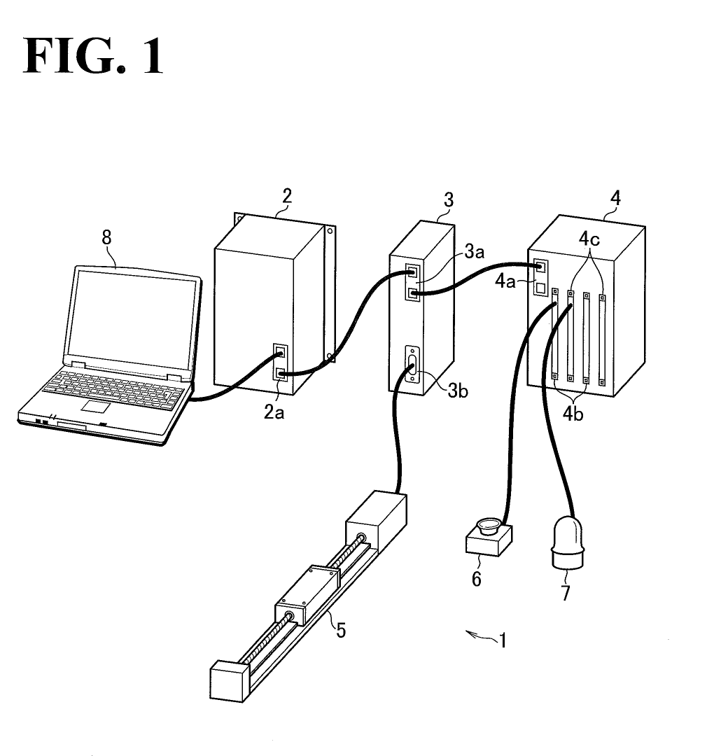

FIG. 1 is a schematic view of a device control system 1 according to this embodiment. As shown in FIG. 1, the device control system 1 includes a controller 2, a servo controller 3, an input/output unit 4, a linear slider 5, a switch 6, a lamp 7, and an operation terminal 8.

The controller 2 is what is called a PLC, which controls at least one device based on a control program. As used herein, the term “control program” means information that describes an operation of a device coupled to the controller 2 in terms of a logical relationship or a time axis. Examples of the control program include, but are not limited to, what is called a ladder program and a time chart. Exemplary control targets of the controller 2 include, but are not limited to, input-output devices such as: motor drive shafts, such as the linear slider 5, that are driven through the servo controller 3; the switch 6; and the lamp 7. A program executed by the controller 2 is input into and stored in the controller 2 as electronic data. The controller 2 includes an information communication connector 2a.

The servo controller 3 is a combination of a servo amplifier to control a servo motor and a control circuit of the servo amplifier. The servo controller 3 is provided with an information communication connector 3a and a servo connector 3b. The information communication connector 3a provides connection with other devices such as the controller 2. The servo connector 3b provides connection with servo mechanisms such as the linear slider 5. In this embodiment, the servo connector 3b is connected with the linear slider 5, which is an exemplary motor drive shaft.

The linear slider 5 is a combination mechanism of a servo motor, an encoder, ball screws, and a slide table. The ball screws are coupled to the output shafts of the servo motor. The slide table is guided by a linear guide and driven by the ball screws. The slide table is driven in accordance with the output of the servo controller 3. As used herein, the term “motor drive shaft” refers to a mechanism driven by a drive source that is an electric motor, such as the servo motor, capable of controlling the amount of driving. The term motor drive shaft is thus called when the electric motor is in focus. The electric motor may be other than the servo motor; other examples include, but are not limited to, a step motor. Also the electric motor may not necessarily provide rotative power; it is also possible to use a linear motor.

The I/O unit 4 includes an information communication connector 4a and a plurality of input-output contact points. The information communication connector 4a provides connection with other devices such as the controller 2. The plurality of input-output contact points are where input-output devices are connected. The input-output contact points of the I/O unit 4 include input connectors 4b and output connectors 4c. The input connectors 4b include a plurality of contact points for input use (which will be referred to as input contact points), and the output connectors 4c include a plurality of contact points for output use (which will be referred to as output contact points). The I/O unit 4 transmits input states of the input contact points of the input connectors 4b to the controller 2 through the information communication connector 4a. The I/O unit 4 also controls states of the output contact points of the output connectors 4c in accordance with a command transmitted from the controller 2 through the information communication connector 4a. A function of the I/O unit 4 is to add external input-output contact points to the controller 2. In this embodiment, exemplary input-output devices connected to the I/O unit 4 are the switch 6 and the lamp 7. The switch 6 is a mechanical switch of the normally open (that is, contact the point A) type and connected to the input connector 4b. The lamp 7 is connected to the output connector 4c. As used herein, the term “input-output contact point” refers to a contact point at which information is input or output depending on highness or lowness of impedance. The term input-output device refers to a device coupled to the controller 2 at an input-output contact point.

In this embodiment, as shown in FIG. 1, the information communication connectors 2a, 3a, and 4a are connected to each other by means of cascade connection through cables. Thus, the controller 2, the servo controller 3, and the I/O unit 4 are communicable with each other. In this embodiment, the connection conforms to the Ethernet (registered trademark) standards, and is of the unoccupied communication type.

The operation terminal 8 is a human machine interface (HMI) to operate a motor drive shaft, which is the linear slider 5 in this embodiment, through the controller 2. The driving of the motor drive shaft that the controller 2 controls through the operation terminal 8 needs to be immediate in synchronization with an instruction from an external device (the operation terminal 8), as opposed to the type of control that executes a preprogrammed operation. Such an operation will be hereinafter referred to as external instruction synchronized drive. The external instruction synchronized drive is approximately analogous to what are generally called jogging, inching, and similar operations.

The operation terminal 8 also serves as a control program generation device, which is not directly related to this embodiment and thus will not be elaborated here. The control program generation device generates a control program to be executed by the controller 2. The generated control program is transferred to and stored in the controller 2.

While the operation terminal 8 may be a dedicated apparatus, the example shown is a general-purpose computer. This computer is implemented as the operation terminal 8 by executing a computer program. The computer program may be stored in any of various light discs or a semiconductor memory such as a computer readable information storage medium, and the computer preferably installs the computer program from the medium. The computer may also download the computer program from any of various information communication networks such as the Internet. The computer program may also be implemented using what is called cloud computing; specifically, the function of the computer program may be provided from a server at a remote place through an information communication network. In this embodiment, the function of the operation terminal 8 is implemented as a part of the control program generation device.

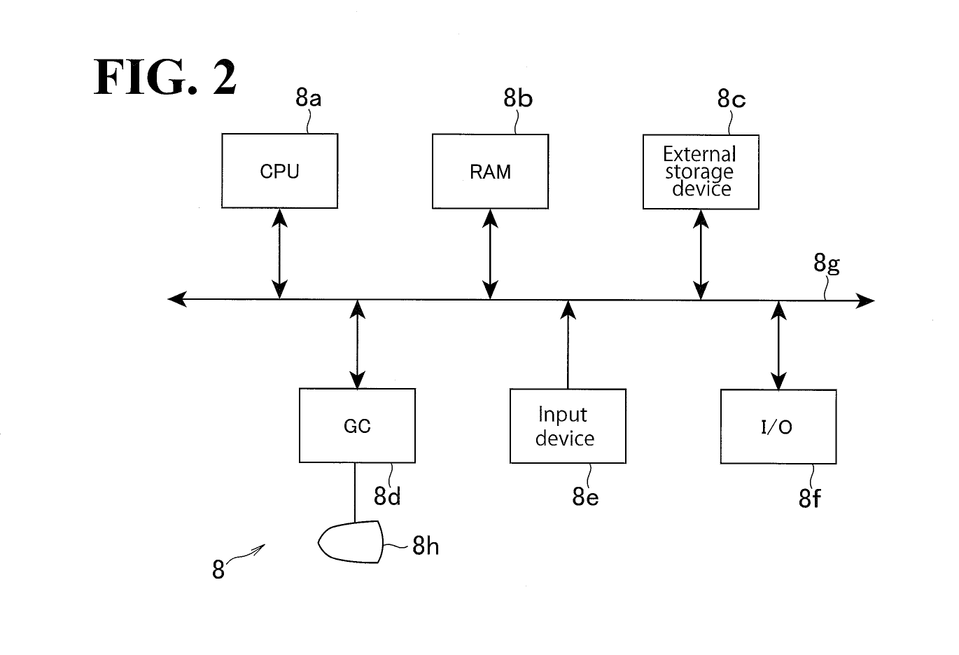

FIG. 2 is a block diagram illustrating a physical configuration of the operation terminal 8. The operation terminal 8 is a general-purpose computer, and includes a CPU (Central Processing Unit) 8a, a RAM (Random Access Memory) 8b, an external storage device 8c, a GC (Graphics Controller) 8d, an input device 8e, and an I/O (Input/Output) 8f. The CPU 8a, the RAM 8b, the external storage device 8c, the GC 8d, the input device 8e, and the I/O 8f are connected to each other through a data bus 8g and thus capable of exchanging electrical signals through the data bus 8g. The external storage device 8c is a device that statically records information. Examples include, but are not limited to, an HDD (Hard Disk Drive) and an SSD (Solid State Drive). The GC 8d outputs a signal to a monitor 8h. The monitor 8h displays the signal in the form of an image. The monitor 8h is for the user to visually recognize the image. Examples of the monitor 8h include, but are not limited to, a CRT (Cathode Ray Tube) and what is called a flat panel display. The input device 8e is a device for the user to input information. Examples of the input device 8e include, but are not limited to, a keyboard, a mouse, and a touch panel. The I/O 8f is an interface on which the operation terminal 8 exchanges information with an external device, which is the controller 2 in this embodiment.

For simplified description and illustration, those configuration details and wiring details irrelevant to understanding of this embodiment are omitted from the above description and FIGS. 1 and 2. For example, a power source line and a ground line are not shown. There is no particular limitation to the form of the connections, the type of the connectors, and the kind and number of the control target devices; any other variations are possible.

### Configuration of the Device Control System According to the Embodiment

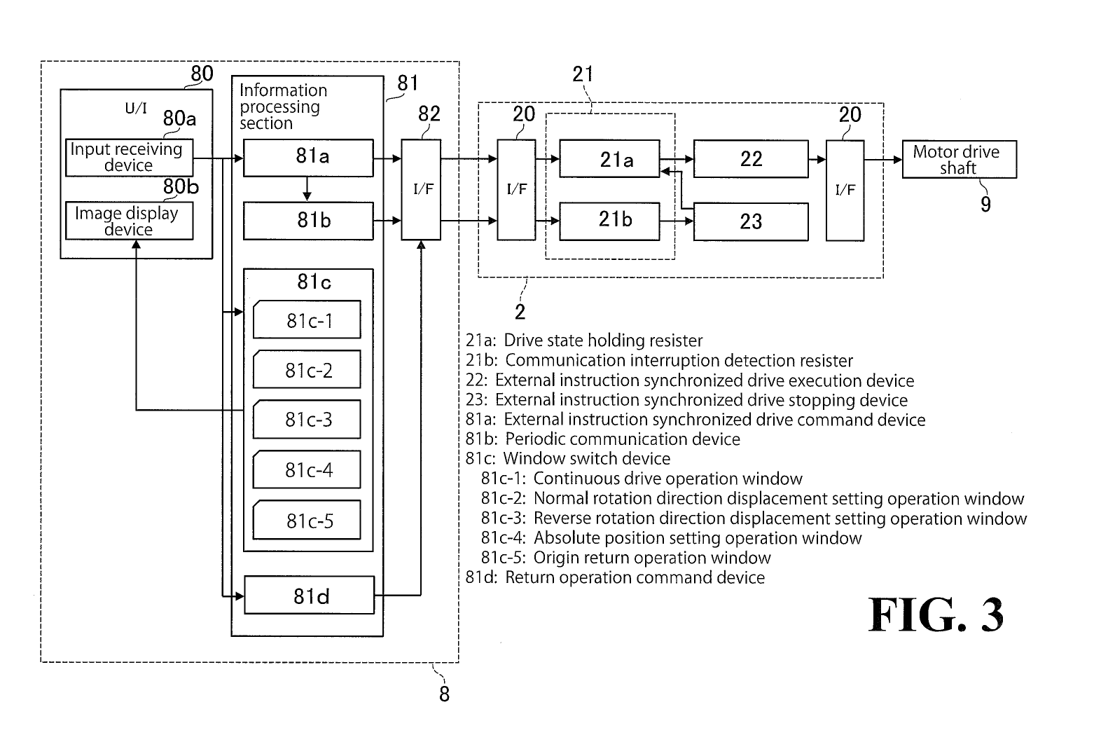

FIG. 3 is a functional block diagram of the device control system 1 according to this embodiment. The operation terminal 8 includes a user interface 80, an information processing section 81, and an interface 82.

The user interface 80 shows information to the user and receives information input from the user. The user interface 80 includes an input receiving device 80a and an image display device 80b. The input receiving device 80a receives information input from the user. The image display device 80b shows information to the user by displaying the information in the form of an image. In this embodiment, the input receiving device 80a corresponds to the input device 8e shown in FIG. 2, and the image display device 80b corresponds to the GC 8d and the monitor 8h, which are as described above by referring to FIG. 2. In particular, in this embodiment, the input device 8e includes what is called a pointing device such as a mouse and a touch panel. With the pointing device, the user is able to make an input by designating coordinates on the image on the image display device 80b.

The information processing section 81 performs various kinds of information processing in the operation terminal 8. Specifically, the information processing section 81 corresponds to the CPU 8a and the work area RAM 8b shown in FIG. 2. As shown in FIG. 3, the information processing section 81 includes an external instruction synchronized drive command device 81a, a periodic communication device 81b, a window switch device 81c, and a return operation command device 81d. These elements are schematically shown in FIG. 3 in the form of blocks corresponding to functions contained in information processing implemented by a program that the information processing section 81 executes. The operations of the blocks will be described later.

The interface 82 provides electrical communication between the operation terminal 8 and an external device, and corresponds to the I/O 8f shown in FIG. 2.

The controller 2 includes interfaces 20, a register 21, an external instruction synchronized drive execution device 22, and an external instruction synchronized drive stopping device 23.

The interface 20 provides electrical communication between the controller 2 and an external device. The controller 2 is coupled to the operation terminal 8 and the motor drive shaft 9 through the interface 20. The motor drive shaft 9 represents a combination of the servo controller 3 and the linear slider 5 shown in FIG. 1.

The register 21 is an information storage area, and may be a semiconductor memory such as a general RAM. A predetermined area of the register 21 is used as a drive state holding register 21a, and another predetermined area of the register 21 is used as a communication interruption detection register 21b. The content of the register 21 is rewritable directly by an external device through the interface 20 using a method such as direct memory access (DMA). This means that the operation terminal 8, which is coupled to the controller 2, is able to rewrite the content of the register 21.

The external instruction synchronized drive execution device 22 transmits a signal as a command for the external instruction synchronized drive to the motor drive shaft 9 through the interface 20. In response, the motor drive shaft 9 executes the external instruction synchronized drive. The external instruction synchronized drive stopping device 23 detects a communication interruption that is due to some causes such as physical breakage of the communication line between the operation terminal 8 and the controller 2. Thus, the external instruction synchronized drive stopping device 23 stops the external instruction synchronized drive. The operations of these blocks will be described in detail later.

For simplified description and illustration, the above-described functional blocks of the device control system 1 are only those functions relevant to understanding of this embodiment, and those functions less relevant are omitted from description. Hence, the device control system 1 may have various other functions in addition to those functions shown in FIG. 3. Where necessary, the following description will refer to FIG. 3.

### Operation of the Device Control System According to the Embodiment

Next, operations of the device control system 1 according to this embodiment will be described. First, in the operation terminal 8, when the input receiving device 80a receives from the user an instruction to start the external instruction synchronized drive, the instruction is transmitted to the external instruction synchronized drive command device 81a. The external instruction synchronized drive command device 81a transmits a signal as a drive command to the controller 2 through the interface 82. The drive command is for the start of the external instruction synchronized drive.

The controller 2 is notified of the drive command by the external instruction synchronized drive command device 81a. Thus, information indicating that the motor drive shaft 9 is in driving state is written and held in the drive state holding resister 21a. This ensures continued indication of the motor drive shaft 9 being in driving state even when the drive command is notified from the operation terminal 8 through the unoccupied communication only once. When the drive state held in the drive state holding resister 21a indicates “driving”, the external instruction synchronized drive execution device 22 transmits a signal to the motor drive shaft 9 through the interface 20. Thus, the external instruction synchronized drive is executed.

In the operation terminal 8, when the input receiving device 80a receives from the user an instruction to stop the external instruction synchronized drive, the instruction is transmitted to the external instruction synchronized drive command device 81a. The external instruction synchronized drive command device 81a transmits a signal as a stopping command to the controller 2 through the interface 82. The stopping command is for stopping of the external instruction synchronized drive.

The controller 2 is notified of the stopping command by the external instruction synchronized drive command device 81a. Thus, information indicating that the motor drive shaft 9 is in stopped state is written and held in the drive state holding resister 21a. When the drive state held in the operation state holding resister 21a indicates “stopped”, the external instruction synchronized drive execution device 22 transmits no signal to the motor drive shaft 9, or transmits a signal (hold signal) to stop the motor drive shaft 9. Thus, the external instruction synchronized drive is stopped.

In the above-described operations, when the communication between the operation terminal 8 and the controller 2 is interrupted after the drive command has been transmitted, the controller 2 is not able to receive the stopping command. In view of this, in the device control system 1 according to this embodiment, upon notification of the drive command, the periodic communication device 81b of the operation terminal 8 communicates with the controller 2 through the interface 82 at a predetermined period. While the predetermined period may be set at any value, an exemplary predetermined period is 100 ms. It may be the user that sets the predetermined period. In this embodiment, the communication performed by the periodic communication device 81b is to write a value into the communication interruption detection resister 21b. The value is changed every time the communication is performed. For example, when the communication interruption detection resister 21b has an eight-bit area, the periodic communication device 81b writes into the communication interruption detection resister 21b a value incremented by 1 (0, 1, 2, 3, . . . ) every time the communication is performed. Upon reaching 255, the value returns to 0. It will be readily appreciated that the value to be written may not necessarily increase by 1 every time the communication is performed. The value may also decrease by 1 or may change under any other rules, insofar as the currently written value differs from the value in the previous communication. The periodic communication device 81b may perform communication regardless of whether the drive command has been made. Still, to avoid unnecessary increase in the communication amount while the motor drive shaft 9 is stopped, the communication is preferably stopped while no drive command is made.

Every time the periodic communication device 81b communicates with the controller 2, a new value is written into the communication interruption detection resister 21b. The value is written at a predetermined period insofar as the communication between the operation terminal 8 and the controller 2 is established. Thus, insofar as the communication between the operation terminal 8 and the controller 2 is not interrupted, the content of the communication interruption detection resister 21b changes at a predetermined period, which is 100 ms in this embodiment.

The external instruction synchronized drive stopping device 23 refers to the content of the communication interruption detection resister 21b at a period equal to or longer than the predetermined period. When the current content of the communication interruption detection resister 21b found in the new reference is different from the content of the communication interruption detection resister 21b found in the previous reference, the external instruction synchronized drive stopping device 23 determines that the communication between the operation terminal 2 and the controller 2 is normal. In this case, the external instruction synchronized drive stopping device 23 performs no processing. When the current content of the communication interruption detection resister 21b found in the new reference is the same as the content of the communication interruption detection resister 21b found in the previous reference, this indicates that the communication between the operation terminal 2 and the controller 2 is interrupted. In this case, the external instruction synchronized drive stopping device 23 writes in the drive state holding resister 21a information indicating that the drive state of the motor drive shaft 9 is “stopped”.

Here, assume that the motor drive shaft 9 is driven under position following control, that is, control to set the current position of the motor drive shaft 9 at a set target position. In this case, the external instruction synchronized drive stopping device 23 writes into the drive state holding resister 21a information indicating that the drive state of the motor drive shaft 9 is “stopped”, and resets the difference between the current position and the target position of the motor drive shaft 9. When the motor drive shaft 9 uses a servo motor, the reset of the difference may be by transmitting a servo-off signal to the servo controller 3 to implement a servo OFF state. It is also possible to simply reset the target position, thereby cancelling the position following control.

In this respect, assume that the motor drive shaft 9 is stopped without reset of the difference between the current position and the target position of the motor drive shaft 9. In this case, the position following control continues through the time when the drive stop state is released. This makes it possible for the motor drive shaft 9 to perform an unexpected operation such as sudden acceleration in an attempt to make up for the difference. In view of this, the external instruction synchronized drive stopping device 23 writes into the drive state holding resister 21a information indicating that the drive state of the motor drive shaft 9 is “stopped”. Then, simultaneously with the motor drive shaft 9 being stopped, the external instruction synchronized drive stopping device 23 resets the difference between the current position and the target position of the motor drive shaft 9. In this manner, the external instruction synchronized drive stopping device 23 prevents an unexpected operation that can occur when the drive stop state is released.

Thus, in the device control system 1 according to this embodiment, the operation terminal 8 is provided with the periodic communication device 81b, and the controller 2 is provided with the communication interruption detection resister 21b and the external instruction synchronized drive stopping device 23. This ensures that the external instruction synchronized drive is immediately stopped when the communication between the operation terminal 8 and the controller 2 is interrupted. The periodic communication from the periodic communication device 81b is detected through the communication interruption detection resister 21b. This is because the operation terminal 8 and the controller 2 are independent devices, and thus it is difficult to synchronize the operations of the periodic communication device 81b and the external instruction synchronized drive stopping device 23 and difficult to provide direct communication between the periodic communication device 81b and the external instruction synchronized drive stopping device 23. Still, it is possible to use a method other than using the communication interruption detection resister 21b described here, insofar as the external instruction synchronized drive stopping device 23 detects the interruption of the periodic communication from the periodic communication device 81b.

The above-described configuration of detecting the interruption of the communication between the operation terminal 8 and the controller 2 is especially effective when the operation terminal 8 and the controller 2 are coupled to one another by the unoccupied communication. Still, the above-described configuration also applies in the case where the operation terminal 8 and the controller 2 are coupled to one another by the occupied communication. Additionally, the detection of the interruption of the communication is also effective for a normal drive command, as well as for use during the external instruction synchronized drive of the motor drive shaft.

### Operation Window of Operation Terminal According to the Embodiment

Next, description will be made by way of examples with regard to an operation window that the operation terminal 8 displays on its image display device 80b and to operations performed on the window.

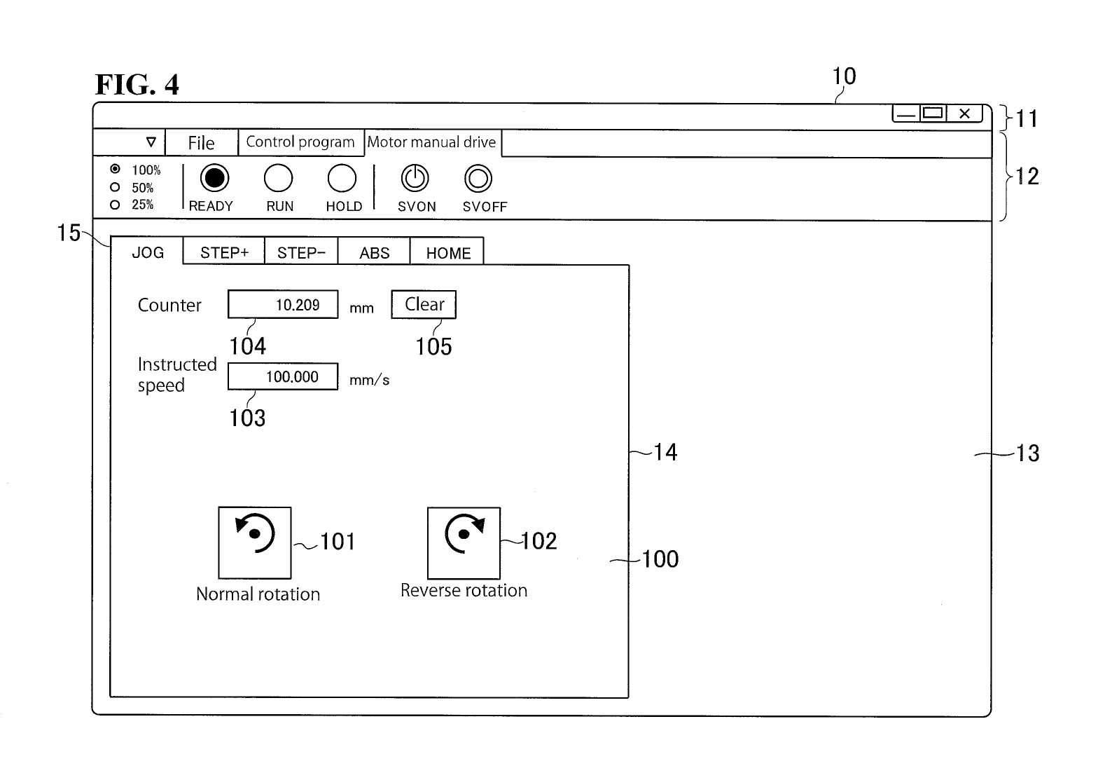

FIG. 4 illustrates an exemplary operation window that the operation terminal 8 displays on its image display device when an operation related to the external instruction synchronized drive is performed. The operation terminal 8 is a general-purpose computer using an OS (Operating System) capable of what is called a multi-task and multi-window view. As shown in FIG. 4, an application to cause the computer to function as the operation terminal 8 is displayed on a window 10. The window 10 described here is an exemplary window that the operation terminal 8 displays, and any changes in design and layout of the window 10 are possible.

A title area 11 is on the top edge of the window 10. Under the title area 11, an area hereinafter referred to as ribbon 12 is disposed. The ribbon 12 contains icons of various commands available to be designated with respect to the operation terminal 8. On top of the ribbon 12, a plurality of kinds of tabs are disposed. The ribbon 12 is switchable among the plurality of kinds of tabs, and in each of the tabs, the ribbon 12 provides different kinds of icons. Since FIG. 4 is concerning an operation related to the external instruction synchronized drive, the “Motor manual drive” tab, which indicates the external instruction synchronized drive, is selected in the ribbon 12. Immediately under the ribbon 12, a work area 13 is disposed. The work area 13 is an area where the user receives visual presentations of various kinds of information and makes various specifications. The display details on the work area 13 may be open to change in conjunction with the ribbon 12 being switched. In this embodiment, an operation window 14 is displayed in the work area 13. The operation window 14 is for operations during the external instruction synchronized drive.

On top of the operation window 14, tabs 15 are disposed. By selecting among the tabs 15, the user selects any one of a plurality of types of the operation window 14. The window switch device 81c shown in FIG. 3 performs the switch among the plurality of types of the operation window 14. When the input from the user received by the input receiving device 80a indicates a selection of a tab 15, the window switch device 81c selectively switches and displays the operation window 14 corresponding to the tab 15. In this embodiment, the operation window 14 includes a continuous drive operation window, a normal rotation direction displacement setting operation window, a reverse rotation direction displacement setting operation window, an absolute position setting operation window, and an origin return operation window, as shown in FIG. 3.

The operation window 14 shown in FIG. 4 is a continuous drive operation window 100. The continuous drive operation window 100 is for an operation of continuously driving the motor drive shaft as the external instruction synchronized drive, in accordance with a continued instruction from the user. More specifically, while the user is pressing (selecting on the window) a normal rotation button 101 or a reverse rotation button 102 displayed on the continuous drive operation window 100, the motor drive shaft is driven in the normal rotation direction or the reverse rotation direction.

The movement speed of the motor drive shaft during the external instruction synchronized drive is set by making an input into an entry field 103. A field 104 is labeled as “Counter” and serves as a current position counter representing a relative position of the motor drive shaft from an arbitral position. A clear button 105 is used to reset the value of the current position counter, that is, set the value of the current position counter at 0. Thus, the current position counter indicates a relative position of the motor drive shaft from the position at the time when the clear button 105 was last pressed. For example, when the clear button 105 is pressed when the motor drive shaft is 400 mm away from the machine origin and then the motor drive shaft moves to a position 600 mm away from the machine origin, 200 mm is displayed in the current position counter field 104. When the motor drive shaft 9 further moves to a position away from the machine origin by 300 mm, −100 mm is displayed in the current position counter field 104.

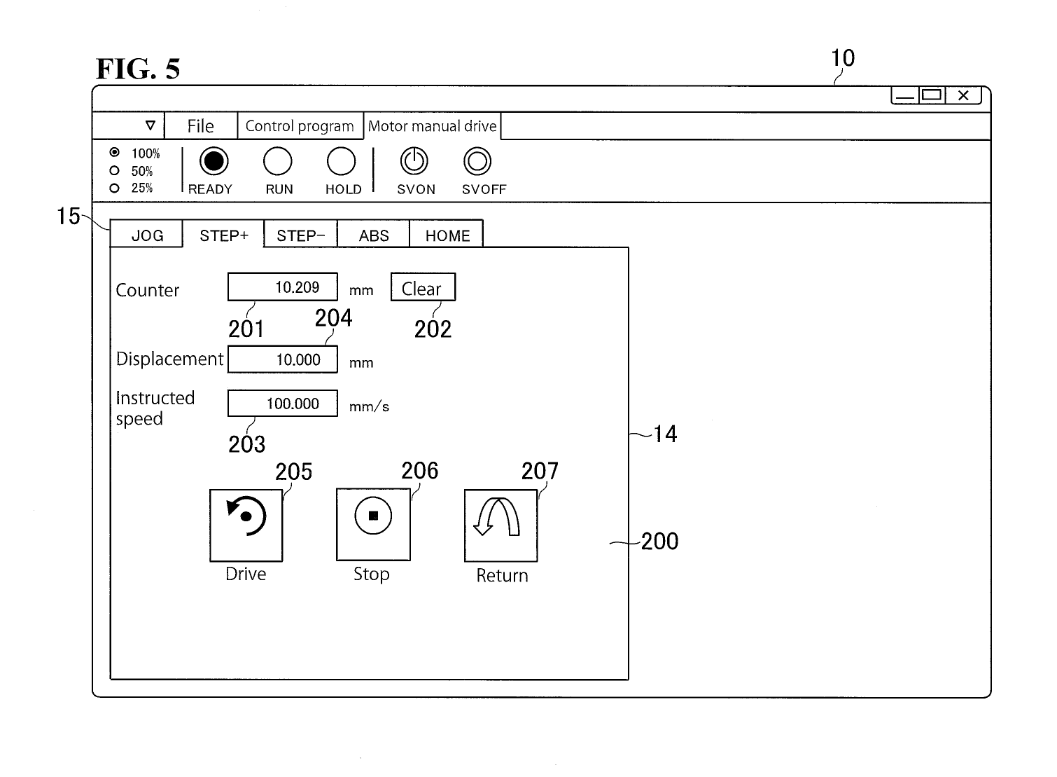

FIG. 5 is a diagram illustrating an exemplary operation window 14 where the normal rotation direction displacement setting operation window 200 is selected as the operation window 14. The normal rotation direction displacement setting operation window 200 is a window for operations of the external instruction synchronized drive including setting the displacement of the motor drive shaft in the form of a numerical value and moving the motor drive shaft in the normal rotation direction. The normal rotation direction displacement setting operation window 200 includes a field 201, a clear button 202, an entry field 203, and an entry field 204. The field 201 serves as a current position counter. The clear button 202 is for resetting the field 201. The entry field 203 is for the movement speed of the motor drive shaft. The entry field 204 is for the displacement of the motor drive shaft. When the user inputs a desired displacement in the entry field 204 and presses a drive button 205, the motor drive shaft drives in the normal rotation direction by the set displacement at the set movement speed.

A stop button 206 is used to stop the motor drive shaft in the middle of driving. A return button 207 is used to make the motor drive shaft return to a state before the previous operation performed on the motor drive shaft. The return button 207 will be described in more detail. When the external instruction synchronized drive command device 81a makes a drive command, the return operation command device 81d stores the displacement of the motor drive shaft or the pre-movement position coordinates of the motor drive shaft. Then, when the return button 207 is operated, the external instruction synchronized drive command device 81a reverses the positivity or negativity of the displacement that is stored, and makes a command to drive the motor drive shaft in the reverse direction by the same distance, or makes a command to drive the motor drive shaft to move back to the position coordinates that are stored. A command is made for the operation of making the motor drive shaft return to the state before the previous operation performed on the motor drive shaft.

The return button 207 may be deactivated to prohibit operation on the return button 207 until the external instruction synchronized drive is executed. It is also possible to prohibit operation on the return button 207 when a tab 15 is operated to make a switch in the operation window 14, or when the external instruction synchronized drive is performed from the operation window 14 corresponding to a window other than the normal rotation direction displacement setting operation window 200. This eliminates or minimizes an unexpected operation caused by accidental operation on the return button 207.

It is also possible to prohibit operation on the return button 207 when the motor drive shaft is already in return-to-origin set state, or when the origin is not set. The prohibition may be set on the operation terminal 8 side or on the controller 2 side. When the operation on the return button 207 is prohibited on the operation terminal 8 side, it is possible to hold information indicating whether the motor drive shaft is in return-to-origin state or indicating whether the origin is set and to, for example, deactivate the return button 207 based on the information. When the operation on the return button 207 is prohibited on the controller 2 side, it is possible to make an alarm or a similar notification when the return button 207 is operated.

The arrangement of the buttons will be described. In the example shown in FIG. 5, the drive button 205 is on the left side of the stop button 206, and the return button 207 is on the right side of the stop button 206.

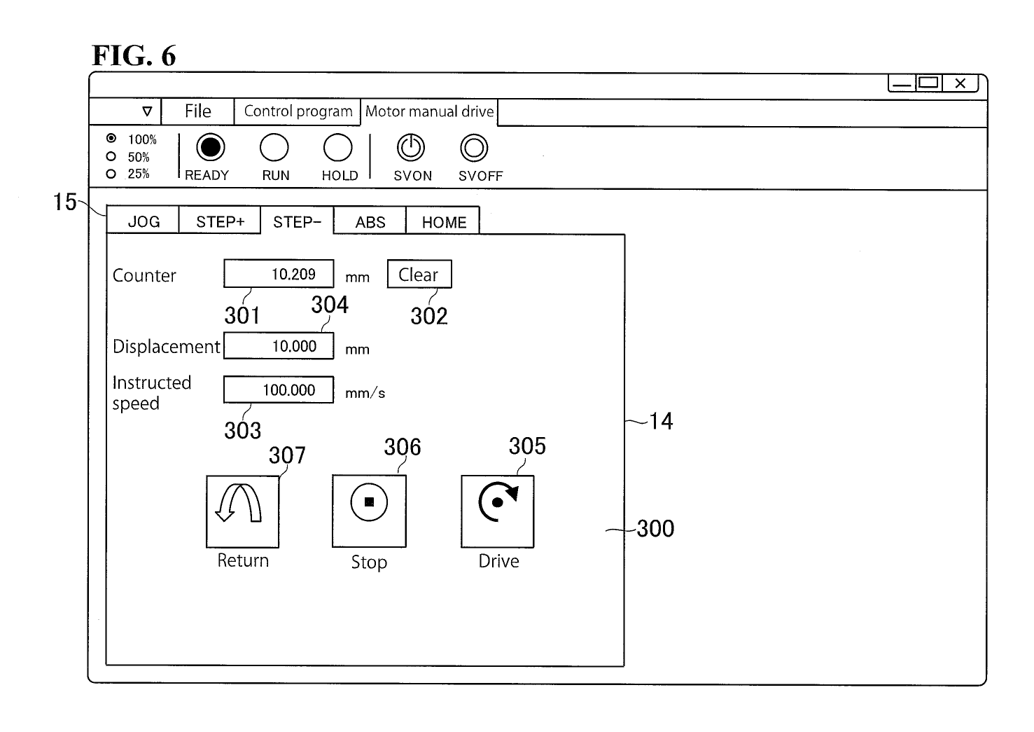

FIG. 6 is a diagram illustrating an exemplary operation window 14 where the reverse rotation direction displacement setting operation window 300 is selected as the operation window 14. The reverse rotation direction displacement setting operation window 300 is a window for operations of the external instruction synchronized drive including setting the displacement of the motor drive shaft in the form of a numerical value and moving the motor drive shaft in the reverse rotation direction. The reverse rotation direction displacement setting operation window 300 is similar in function to the normal rotation direction displacement setting operation window 200 shown in FIG. 5, with one difference being that the motor drive shaft rotates in a different direction. Another similarity is that the reverse rotation direction displacement setting operation window 300 includes a field 301 as a current position counter, a clear button 302 to reset the current position counter, an entry field 303 for the movement speed of the motor drive shaft, and an entry field 304 for the displacement of the motor drive shaft. A drive button 305, a stop button 306, and a return button 307 respectively have similar functions to functions of the drive button 205, the stop button 206, and the return button 207.

In the reverse rotation direction displacement setting operation window 300, the drive button 305 is on the right side of the stop button 306, and the return button 307 is on the left side of the stop button 306. This order of arrangement is opposite to the order of arrangement in the normal rotation direction displacement setting operation window 200 shown in FIG. 5. In other words, the normal rotation direction displacement setting operation window 200 and the reverse rotation direction displacement setting operation window 300 are opposite to each other in the position relationship between the drive button, which is a motor drive shaft operation instruction image on which to instruct the operation of the motor drive shaft, and the return button, which is a return operation setting image on which to instruct the return operation.

This will be described in detail. When the displacement is set to move the motor drive shaft, once an instruction for driving is made, the motor drive shaft automatically continues to move by the set displacement unless the stop button is pressed. In such an operation, if the normal rotation of the motor drive shaft is mistaken as the reverse rotation or when the reverse rotation is mistaken as the normal rotation, an interference between devices or similar situations can occur. In view of this, in this embodiment, the normal rotation direction displacement setting operation window 200 and the reverse rotation direction displacement setting operation window 300 are separate from each other and selectively switchable so that only one of the windows 200 and 300 is displayed. Thus, the drive button 205 for the normal rotation direction and the drive button 305 for the reverse rotation direction are not displayed at the same time. This eliminates or minimizes erroneous selection of the buttons. Furthermore, in this embodiment, the drive button 205 for the normal rotation direction and the drive button 305 for the reverse rotation direction are at on mutually opposite positions. Thus, one drive button is not displayed on the same coordinates of the other drive button, and one return button is not displayed on the same coordinates of the other return button. This eliminates or minimizes such a situation that the normal rotation of the motor drive shaft is mistaken as the reverse rotation, or the reverse rotation is mistaken as the normal rotation even when a wrong tab 15 is selected. This, in turn, improves the safety of driving the motor drive shaft.

Preferably, the displacement input into the entry field 204 in the normal rotation direction displacement setting operation window 200 is set and held independently of the displacement input into the entry field 304 in the reverse rotation direction displacement setting operation window 300. In other words, the displacement input into the entry field 204 in the normal rotation direction displacement setting operation window 200 preferably does not affect the displacement in the reverse rotation direction displacement setting operation window 300. Similarly, the displacement input into the entry field 304 in the reverse rotation direction displacement setting operation window 300 preferably does not affect the displacement in the normal rotation direction displacement setting operation window 200.

Thus, when the drive in the normal rotation direction and the drive in the reverse rotation direction repeat with mutually different displacements, it is not necessary to input the displacements on every drive occasion, which improves operability. For example, assume that a 10-mm movement of the motor drive shaft in the normal rotation direction repeats five times, and then a 50-mm movement of the motor drive shaft in the reverse rotation direction returns the motor drive shaft to its original position. In this case, 10 mm is input into the entry field 204 in the normal rotation direction displacement setting operation window 200, and 50 mm is input into the entry field 304 in the reverse rotation direction displacement setting operation window 300. This eliminates the need for inputting the displacements every time an instruction is made to move the motor drive shaft. For the movement of the motor drive shaft back to its original position (movement in the reverse rotation direction in this embodiment), only a single instruction is necessary. Furthermore, when a displacement is input into the entry field 204 in the normal rotation direction displacement setting operation window 200, this displacement does not unintentionally change the displacement input into the entry field 304 in the reverse rotation direction displacement setting operation window 300. Similarly, when a displacement is input into the entry field 304 in the reverse rotation direction displacement setting operation window 300, this displacement does not unintentionally change the displacement input into the entry field 204 in the normal rotation direction displacement setting operation window 200. This eliminates or minimizes unexpected situations such as the motor drive shaft operating by an unintended displacement.

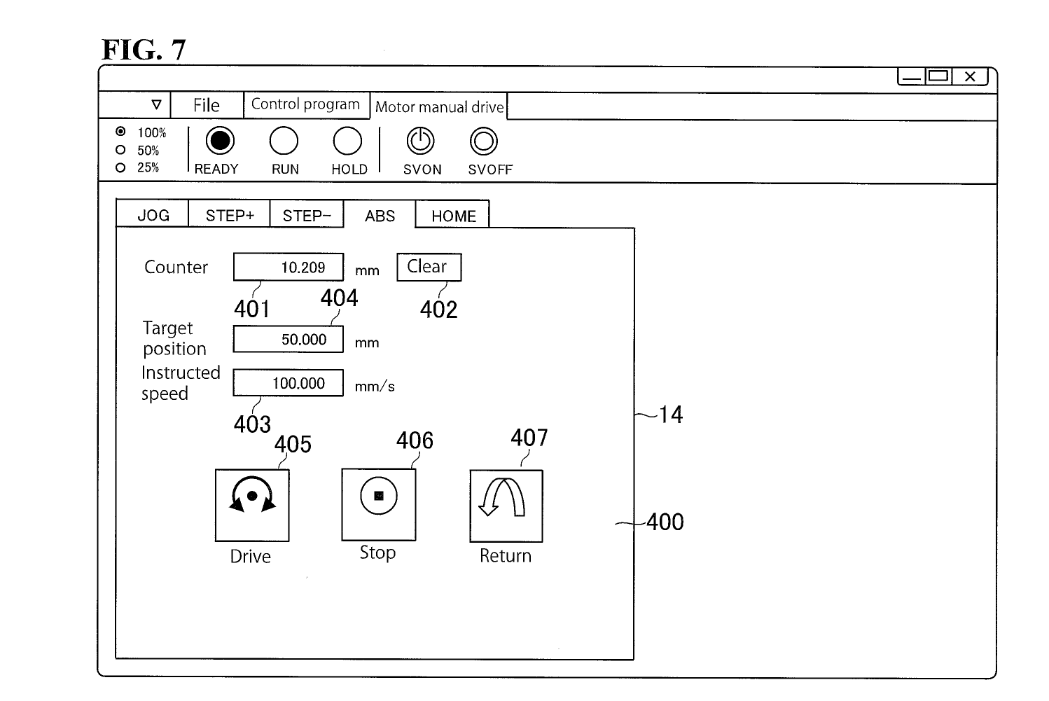

FIG. 7 is diagram illustrating an exemplary operation window 14 where the absolute position setting operation window 400 is selected as the operation window 14. The absolute position setting operation window 400 is a window for operations of the external instruction synchronized drive including setting the movement destination position of the motor drive shaft in the form of a numerical value, and moving the motor drive shaft. The absolute position setting operation window 400 includes a field 401, a clear button 402, an entry field 403, and an entry field 404. The field 401 serves as a current position counter. The clear button 402 is for resetting the field 401. The entry field 403 is for the movement speed of the motor drive shaft. The entry field 404 is for setting the target position. A desired displacement is input into the entry field 404 and then the drive button 405 is pressed. This causes the motor drive shaft to move to the set target position at the set movement speed. The rotational direction of the motor drive shaft is determined by the position relationship between the current position and the target position.

The stop button 406 is used to stop the motor drive shaft in the middle of driving. The return button 407 is used to return the motor drive shaft to a state before the previous operation performed on the motor drive shaft.

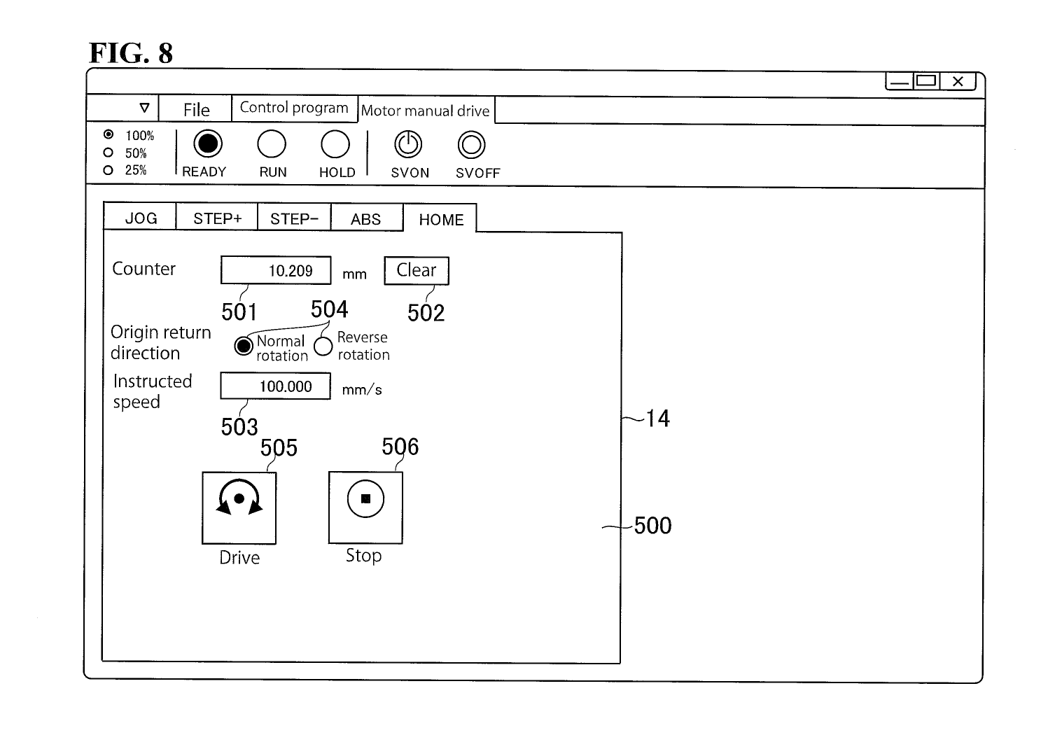

Finally, FIG. 8 is diagram illustrating an exemplary operation window 14 where the origin return operation window 500 is selected as the operation window 14. The origin return operation window 500 is a window for operations of as the external instruction synchronized drive including moving the motor drive shaft in at least one of the normal and the reverse rotation directions until the mechanical origin is detected, so as to set the origin position. The origin return operation window 500 includes a field 501, a clear button 502, an entry field 503, and a radio button 504. The field 501 serves as a current position counter. The clear button 502 is for resetting the field 501. The entry field 503 is for the movement speed of the motor drive shaft. The radio button 504 is for setting the origin return direction. The origin return direction is set and then the drive button 505 is pressed. This causes the motor drive shaft to start driving in the set direction at the set movement speed. Then, upon detection of the mechanical origin, the motor drive shaft is stopped. The position where the mechanical origin is detected is set as the origin position. A stop button 506 is used to stop the motor drive shaft in the middle of driving.

In order to set the origin return operations in more detail, it is possible to provide other entry fields than the field shown in FIG. 8. For example, when the motor drive shaft is decelerated stepwise in its movement to the mechanical origin, it is possible to input a movement speed in each step. It is also possible to change an algorithm for moving the motor drive shaft to the mechanical origin.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A device control system comprising:
a controller configured to control a device comprising a motor drive shaft; and
an operation terminal communicably coupled to the controller, the operation terminal comprising:
an external instruction synchronized drive command device configured to notify the controller of a drive command for external instruction synchronized drive of the motor drive shaft; and
a periodic communication device configured to communicate with the controller at a predetermined period at least during the external instruction synchronized drive,
the controller comprising:
an external instruction synchronized drive execution device configured to execute the external instruction synchronized drive based on the drive command; and
an external instruction synchronized operation execution stopping device configured to monitor communication from the periodic communication device at least during the external instruction synchronized drive, and configured to stop the external instruction synchronized drive when the communication from the periodic communication device is interrupted.

2. The device control system according to claim 1,
wherein the controller comprises a drive state holding resister configured to hold a drive state of the external instruction synchronized drive,
wherein the drive command rewrites the drive state held by the drive state holding resister from stopping to driving,
wherein the external instruction synchronized drive execution device is configured to execute the external instruction synchronized drive when the drive state held by the drive state holding resister is driving, and
wherein the external instruction synchronized drive execution device is configured to rewrite the drive state held by the drive state holding resister from driving to stopping when the communication from the periodic communication device is interrupted.

3. The device control system according to claim 1,
wherein the controller comprises a communication interruption detection resister rewritable through unoccupied communication,
wherein the periodic communication device is configured to rewrite a content of the communication interruption detection resister at a predetermined period, and
wherein the external instruction synchronized drive stopping device is configured to refer to the content of the communication interruption detection resister at the predetermined period, and to determine that the communication from the periodic communication device is interrupted when a value of the communication interruption detection resister is unchanged.

4. The device control system according to claim 1, wherein when the external instruction synchronized drive stopping device stops the external instruction synchronized drive, the external instruction synchronized drive stopping device is configured to reset a difference between a current position of the motor drive shaft and a target position of the motor drive shaft.

5. A device control system comprising:
a controller configured to control a device comprising a motor drive shaft; and
an operation terminal communicatively coupled to the controller, the operation terminal comprising a periodic communication device configured to communicate with the controller at a predetermined period,
wherein the controller is configured to monitor communication from the periodic communication device, and configured to stop the motor drive shaft when the communication from the periodic communication device is interrupted.

6. The device control system according to claim 1, wherein the operation terminal is configured to selectively switch between a normal rotation direction displacement setting operation window and a reverse rotation direction displacement setting operation window, and configured to display the selected window on an image display device, the normal rotation direction displacement setting operation window being for instructing a normal rotation direction movement of the motor drive shaft, the reverse rotation direction displacement setting operation window being for instructing a reverse rotation direction movement of the motor drive shaft.

7. The device control unit according to claim 6, wherein a position relationship between a motor drive shaft operation instruction image and a return operation instruction image in the normal rotation direction displacement setting operation window is opposite to a position relationship between the motor drive shaft operation instruction image and the return operation instruction image in the reverse rotation direction displacement setting operation window.

8. The device control system according to claim 6, wherein a displacement in the normal rotation direction displacement setting operation window and a displacement in the reverse rotation direction displacement setting operation window are set independently from each other.

9. The device control system according to claim 1,
wherein the operation terminal is configured to display a return operation instruction window on the image display device, and
wherein the operation terminal comprises a return operation command device configured to, in response to an instruction on the return operation instruction window, make a command for an operation of returning the motor drive shaft to a state before a previous operation performed on the motor drive shaft.

10. A controller used in the device control system according to claim 1.

11. The device control system according to claim 2,
wherein the controller comprises a communication interruption detection resister rewritable through unoccupied communication,
wherein the periodic communication device is configured to rewrite a content of the communication interruption detection resister at a predetermined period, and
wherein the external instruction synchronized drive stopping device is configured to refer to the content of the communication interruption detection resister at the predetermined period, and to determine that the communication from the periodic communication device is interrupted when a value of the communication interruption detection resister is unchanged.

12. The device control system according to claim 2, wherein when the external instruction synchronized drive stopping device stops the external instruction synchronized drive, the external instruction synchronized drive stopping device is configured to reset a difference between a current position of the motor drive shaft and a target position of the motor drive shaft.

13. The device control system according to claim 3, wherein when the external instruction synchronized drive stopping device stops the external instruction synchronized drive, the external instruction synchronized drive stopping device is configured to reset a difference between a current position of the motor drive shaft and a target position of the motor drive shaft.

14. The device control system according to claim 11, wherein when the external instruction synchronized drive stopping device stops the external instruction synchronized drive, the external instruction synchronized drive stopping device is configured to reset a difference between a current position of the motor drive shaft and a target position of the motor drive shaft.

15. The device control system according to claim 2, wherein the operation terminal is configured to selectively switch between a normal rotation direction displacement setting operation window and a reverse rotation direction displacement setting operation window, and configured to display the selected window on the image display device, the normal rotation direction displacement setting operation window being for instructing a normal rotation direction movement of the motor drive shaft, the reverse rotation direction displacement setting operation window being for instructing a reverse rotation direction movement of the motor drive shaft.

16. The device control system according to claim 3, wherein the operation terminal is configured to selectively switch between a normal rotation direction displacement setting operation window and a reverse rotation direction displacement setting operation window, and configured to display the selected window on the image display device, the normal rotation direction displacement setting operation window being for instructing a normal rotation direction movement of the motor drive shaft, the reverse rotation direction displacement setting operation window being for instructing a reverse rotation direction movement of the motor drive shaft.

17. The device control system according to claim 4, wherein the operation terminal is configured to selectively switch between a normal rotation direction displacement setting operation window and a reverse rotation direction displacement setting operation window, and configured to display the selected window on the image display device, the normal rotation direction displacement setting operation window being for instructing a normal rotation direction movement of the motor drive shaft, the reverse rotation direction displacement setting operation window being for instructing a reverse rotation direction movement of the motor drive shaft.

18. The device control system according to claim 5, wherein the operation terminal is configured to selectively switch between a normal rotation direction displacement setting operation window and a reverse rotation direction displacement setting operation window, and configured to display the selected window on the image display device, the normal rotation direction displacement setting operation window being for instructing a normal rotation direction movement of the motor drive shaft, the reverse rotation direction displacement setting operation window being for instructing a reverse rotation direction movement of the motor drive shaft.

19. The device control system according to claim 11, wherein the operation terminal is configured to selectively switch between a normal rotation direction displacement setting operation window and a reverse rotation direction displacement setting operation window, and configured to display the selected window on the image display device, the normal rotation direction displacement setting operation window being for instructing a normal rotation direction movement of the motor drive shaft, the reverse rotation direction displacement setting operation window being for instructing a reverse rotation direction movement of the motor drive shaft.

20. The device control system according to claim 12, wherein the operation terminal is configured to selectively switch between a normal rotation direction displacement setting operation window and a reverse rotation direction displacement setting operation window, and configured to display the selected window on the image display device, the normal rotation direction displacement setting operation window being for instructing a normal rotation direction movement of the motor drive shaft, the reverse rotation direction displacement setting operation window being for instructing a reverse rotation direction movement of the motor drive shaft.
